(19) United States
(12) Patent Application Publication
(10) Pub. No.: US 2023/0202154 A1
(43) Pub. Date: Jun. 29, 2023

(54) Systems, Apparatus, and Methods for Creating Thin Plastic Films

(71) Applicant: Paragon Films, Inc., Broken Arrow, OK (US)

(72) Inventors: Tom ROUDEBUSH, Broken Arrow, OK (US); Shaun Eugene PIRTLE, Broken Arrow, OK (US); Khurrum SHAMSI, Broken Arrow, OK (US); Robert Earl COCHLIN, Broken Arrow, OK (US)

(21) Appl. No.: 18/114,819

(22) Filed: Feb. 27, 2023

Related U.S. Application Data
(63) Continuation-in-part of application No. 17/715,410, filed on Apr. 7, 2022.
(60) Provisional application No. 63/171,760, filed on Apr. 7, 2021.
(60) Provisional application No. 63/342,434, filed on May 16, 2022.

(51) Int. Cl. B32B 27/08; B32B 27/32; B32B 3/02; B01D 29/05

(52) U.S. Cl. CPC B32B 27/08; B32B 27/32; B32B 3/02; B01D 29/05; B32B 2272/00; B32B 2250/242; B32B 2250/05; B32B 2250/42; B32B 2307/72; B32B 2307/732; B32B 2553/00; B29C 48/0022

(57) ABSTRACT

A multi-layer film comprising, an outer two layers of the multi-layer film comprising a linear low density polyethylene (LLDPE) butene resin, a next two inwardly successive layers of the multi-layer film comprising a linear low density polyethylene (LLDPE) hexene resin, wherein at least one of the next two inwardly successive layers comprises one or more recycled resin components, wherein at least one of the one or more recycled resin components are filtered using continuous filtration, a core layer of the multi-layer film comprising a linear low density polyethylene (LLDPE) hexene resin, and at least one edge of the multi-layer film comprising a folded edge.

### RELATED APPLICATIONS

This application is a continuation in part application of U.S. application Ser. No. 17/715,410, filed Apr. 7, 2022, which claims priority to U.S. Application No. 63/171,760, filed Apr. 7, 2021. This application claims priority to U.S. Application No. 63/342,434, filed May 16, 2022.

### TECHNICAL FIELD

The disclosure herein relates generally to compositions of and methods for producing high performance plastic films (or films).

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE FIGURES

FIG. 1 shows an extruder screw, under an embodiment.

FIG. 2 shows sections of an extruder screw, under an embodiment.

FIG. 3A shows a coat hanger die, under an embodiment.

FIG. 3B shows a coat hanger die, under an embodiment.

FIG. 3C shows a coat hanger die, under an embodiment.

FIG. 3D shows a coat hanger die, under an embodiment.

FIG. 4A shows a T-Slot die, under an embodiment.

FIG. 4B shows a T-Slot die, under an embodiment.

FIG. 5 shows production of a five layer film, under an embodiment.

FIG. 6 shows production of a multi-layered film, under an embodiment.

FIG. 7 shows steps for producing a film, under an embodiment.

FIG. 8 shows a coextrusion line, under an embodiment.

FIG. 9 shows steps for producing a film, under an embodiment.

FIG. 10 shows a coextrusion line, under an embodiment.

FIG. 11 shows provides an overview of a plastic film coextrusion process, under an embodiment.

FIG. 12 shows a folding process, under an embodiment.

FIG. 13 shows a folding process, under an embodiment.

FIG. 14 shows examples of folds, under an embodiment.

FIG. 15 shows examples of folds, under an embodiment.

FIG. 16 shows a roll of film, under an embodiment.

FIG. 17 shows a roll of film under an embodiment.

FIG. 18 shows a winding/oscillating/air entrapment process, under an embodiment.

### BACKGROUND

Stretch films or cast films (otherwise referred to as films or plastic films) are widely used in a variety of bundling and packaging applications. For example, stretch films have become a common method of securing bulky loads such as boxes, merchandise, produce, equipment, parts, and other similar items on pallets. Such films are typically made from various polyethylene (and/or polypropylene) resins and may be single or multilayer products.

### DETAILED DESCRIPTION

Thin plastic films, e.g. films on the order of six micrometers (microns), have significant advantages of admitting to a more sustainable footprint and allowing users to accomplish a task using less film. The embodiments described herein employ in-line manufacturing processes (as further described below) to produce thinner gauge plastic films. An in line process is described that produces plastic films in a continuous uninterrupted process, wherein the process incorporates (among other steps) slitting a film, folding resulting edges, and winding the film using an oscillating and air entrapment method. The folding and winding/oscillating/air entrapment steps are described in U.S. Pat. Nos. 8,100,356; 8,221,298; 8,475,349; and 8,777,829 which are incorporated herein by reference in their entireties. (Note that embodiments of an in line process may include additional steps, different steps, fewer steps, and/or steps in a differing order). Using embodiments of a formulation described below, an in-line process may provide functional film structures with thicknesses of 6 microns or less.

This in line process of course comprises a process of plastics extrusion, under an embodiment. Plastics extrusion is a high-volume manufacturing process in which raw plastic is melted and formed into a continuous profile. Extrusion produces plastic films among other industrial products and other materials. Typically, the cast film (otherwise referred to as stretch film, plastic film, or film) process involves the use of coextrusion, which is a simultaneous extrusion of two or more materials from a single die to form a multi-layered film. This is because in many cases the final application of the plastic film demands a performance that cannot be achieved if the film is composed of only one material. The number of layers, their position in the coextrudate and their individual thickness are all variables that change depending on the particular application of the film. Desirable properties of film include one or more of the following: Puncture Resistance, Tear Resistance, Cling, Stretch Ability, Resistance to Stretch, Clarity and/or other properties.

This process starts by feeding plastic material (pellets, granules, flakes or powders) from a hopper into the barrel of the extruder. The material is gradually melted by the mechanical energy generated by turning screws and/or by heaters arranged along the barrel. The molten polymer is then forced into a die, which shapes the polymer into a shape that hardens during cooling.

Either a volumetric or gravimetric feeding system controls supply of feed material. Gravimetric feeding systems control the amount of material that is fed into the extruders by weight, not volume. The system is more precise than its volumetric counterpart. A gravimetric feeder, also known as a loss-in-weight feeder, is a self-calibrating dosing system that doses based on weight in speed. A volumetric feeder, on the other hand, does this based on volume in speed. In gravimetric dosing, the weight of the dosed additive is measured using a load cell that is the foundation of the entire system. Weight is calculated using loss-in-weight technology, which measures the reduced weight while dosing.

A volumetric feeder is a dosing system that supplies the production system with a certain volume of material in a set timeframe, based on the so-called displacement principle. In contrast to a gravimetric feeder, the dosing speed of a volumetric feeder should be selected manually, which may vary based on the nature of the raw input materials.

A gravimetric feeder is preferred and provides the following advantages:
Self-adjusting/self-calibrating
100% control over your product quality
Easy to operate
Monitoring and reporting options
Higher saving on expensive additives
Fluctuations in density do not effect outcome
In-sensitive to material build-up
Automatic detection of material supply interruption
Accurate dosing cylinder
Variable motor speed

The main functions of an extruder are to melt the plastics pellets and mix the resulting molten polymer to achieve a homogeneous melt. This is done by conveying the material along a barrel with a rotating screw. The material is gradually melted by the mechanical energy generated by one or more extruder screws. Additional heating may be applied. However, mechanical energy of the extruder screw may be sufficient, under an embodiment. The molten polymer is then forced into a die, which shapes the polymer into a shape.

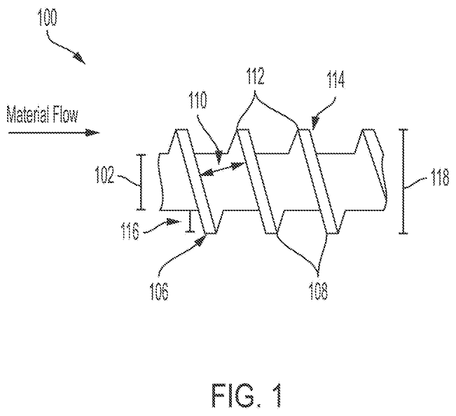

As seen in FIG. 1, an extruder screw 100 comprises a helical structure. The laterally extending helical ribs may be referred to as flights 106, 120. The root 102 of the screw is the inner cylinder from which the helical flights laterally extend. Channel width 110 comprises a distance between flights along a line orthogonal to parallel tangential planes passing along the inner sides of neighboring flights. A helical angle 114 comprises the angle between a tangential plane passing along an edge of a flight and the longitudinal axis of the extruder screw inner cylinder (i.e., the root). Channel flight 108 and pitch 112 are the longitudinal distances between facing and successive surfaces of neighboring flights along respective lines parallel to a longitudinal axis of the root 102.

A side of a flight facing in a direction of the die (or opposing material flow) comprises a pushing flight 120 while an opposing side comprises a trailing flight 106. FIG. 1 illustrates channel depth 116 as the lateral distance from an outer surface of the root to an uppermost edge of a flight measured along a line orthogonal to an axis of the root while extruder screw diameter 118 comprises lateral distance between opposing outer edges of the helical flights passing through the same axis.

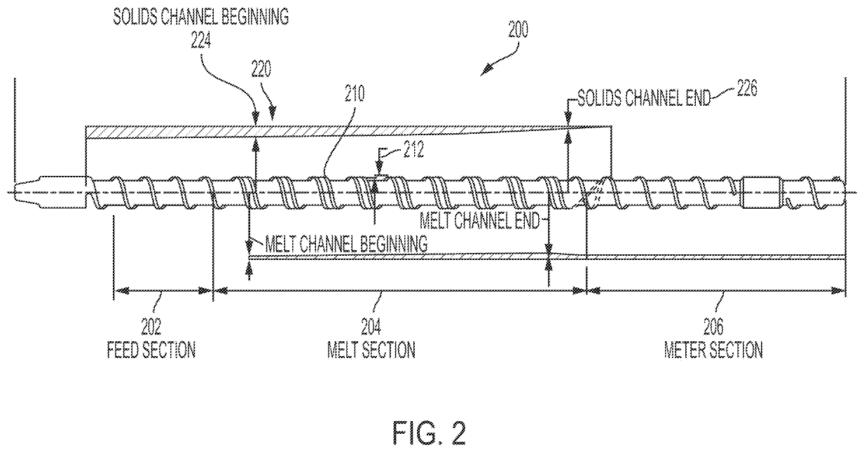

FIG. 2 shows three sections of an extruder screw 200 including a feed section 202, an interior melt section 204, and metering section 206. A solids channel 220 comprises the feed section and the melt section. FIG. 2 shows a solids channel beginning 224 and a solids channel end 226. The extruder screw rotates around a longitudinal axis and pushes material forward through the feed, melt, and meter sections. The extruder screw of FIG. 2 introduces an auxiliary flight, or barrier flight, within the transition or melt section. An auxiliary flight (barrier flight) 210 in the channel is undercut and permits the passage of only fully molten plastic. An auxiliary flight undercut 212 effectively separates a “solid channel” and “melt channel.” The solid channel is open to the feed or solid channel section while the melt channel is open to the metering section. As solid material melts along the length of the feed screw, the melted polymer flows over the barrier flight into the melt channel through a tight clearance. The barrier clearance prevents any unmelted pellets from flowing into the melt channel. The molten and compressed polymer then enters the metering section 206. The flight or channel depth is less than in the feeding zone. The function of the metering section is to build-up pressure. The amount of pressure that can be build-up, depends on the length of the metering zone. The metering section 206 is meant to stabilize the output and develop pressure to overcome the resistance of the die and downstream apparatus.

The melted materials or resins are then filtered and fed to a die system. The objective of the filtration system is to prevent downstream passage of melt impurities and/or gels that are formed during the extrusion process. Proper control at this stage is imperative to prevent melt contamination. The most common filters are those containing a metallic mesh. The case hosting the filter media has to be capable of bearing the forces exerted by the polymer flow when subjected to the maximum pressure allowed by the extrusion process. It is preferred to use continuous screen changers, in which the mesh is continuously regenerated, to minimize the replacement time of the screen pack.

It can be said that the die system is the heart of any coextrusion line. The die system is formed by the coextrusion feedblock, the flat die and the melt transfer adapters that transport the different molten polymers from the extruders to the feedblock inlet ports. The quality of the coextruded film and the productivity of the process are greatly dependent on the design and performance qualities of the die system.

The functions of the die are (i) to force the melt into a thin film, (ii) to maintain the melt at a constant temperature, and (iii) to meter the melt at a constant pressure and rate to the die land for uniform film gauge. The die lands generate resistance to the melt flow and build up backpressure in the die. If the land length is too short, the melt flow out of the die may be uneven. Die lips, or jaws, can be adjusted to change the die opening to control gauge uniformity.

There are two basic types of die designs: “Coat-hanger” dies and “T-slot” dies. In the coat-hanger design, the die manifold, which generally has a teardrop or half teardrop cross section, distributes the incoming melt flow across a steadily widening area. The area ahead of the land streamlines the melt into a film. The T-slot design uses a large volume, circular or teardrop-shaped manifold to minimize melt flow resistance to the die ends. This type of die is normally used with high melt flow resins. With this type of die, the formation of film edge beads is less than it is with “coat-hanger” dies. With both types of dies, a die lip gives the melt its proper cross-sectional thickness and width.

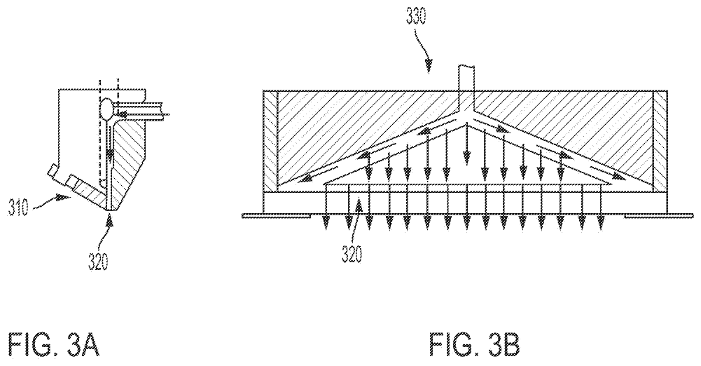

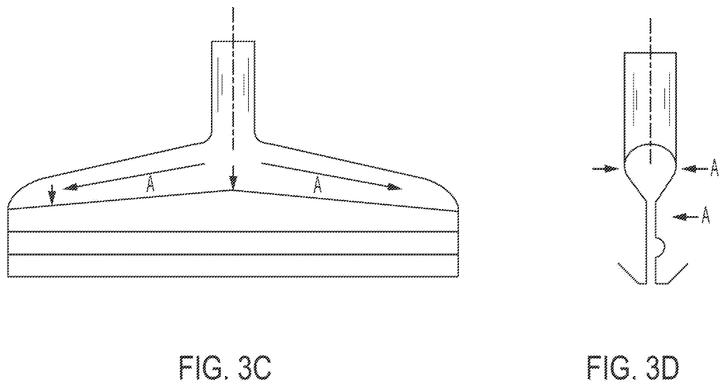

FIG. 3A is a side cross sectional view of a coat hanger die, under an embodiment. FIG. 3A shows a die land and an adjustable jaw for adjusting width of the die land. FIG. 3B shows a front cross sectional view of a coat hander die, under an embodiment. FIG. 3B shows the coat hanger die cross sectional profile and die land.

FIGS. 3C and 3D show a front and side cross sectional view of a coat hanger die volumetrically diminishing manifold. A longitudinally directed section of the manifold decreases in width as it approaches the die land.

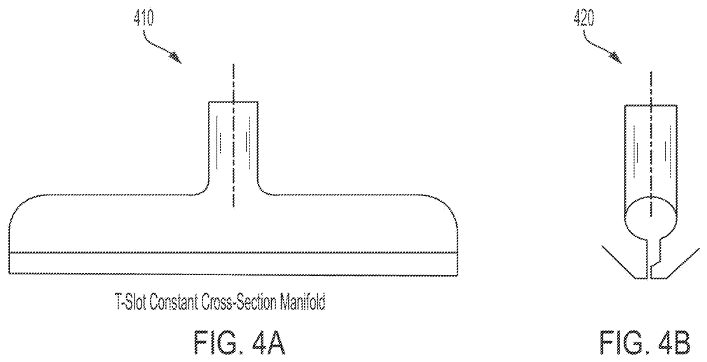

FIGS. 4A and 4B show a front and side cross sectional view of a T-Slot constant cross section manifold, under an embodiment.

The primary function of the die system is to form a multi-layered film that is uniformly distributed across the width of the die with thickness variations on the film and thickness variations on each individual layer within industry accepted tolerances. The coextrusion feedblock arranges the different melt streams in a predetermined layer sequence and generates as many melt streams as layers are to be in the final coextrudate. Once this is done, each stream adopts a planar geometry, meets its neighboring layers and the final planar coextrudate is formed.

The coextrusion methods described below may use either a Coat Hanger or a T-Slot die.

As indicated above, coextrusion is the extrusion of multiple layers of material simultaneously. This type of extrusion utilizes two or more extruders to melt and deliver a steady volumetric throughput of different viscous plastics to a single extrusion head (die) which will extrude the materials in the desired form. Separate extruders are required for each distinct material in the coextrusion. Note that the number of extruders depends on the number of different materials being extruded and not necessarily on the number of layers. This is because the existing feedblock and die technology allows the flow from one extruder to be split into two or more layers in the final coextrudate.

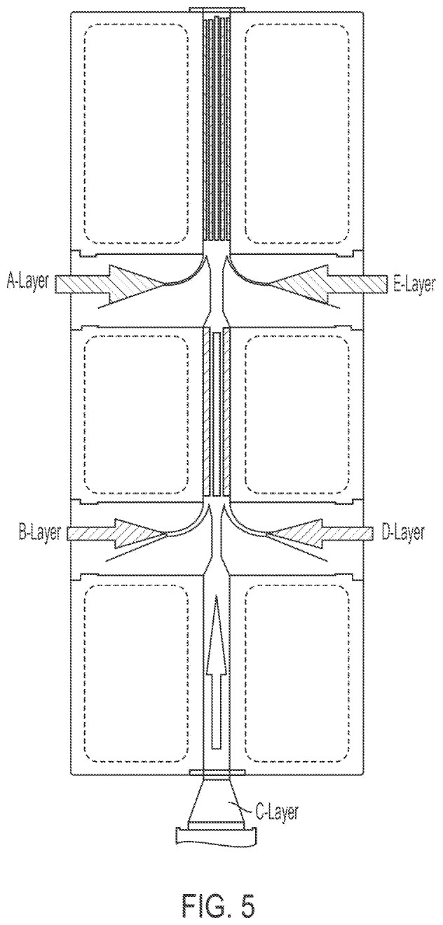

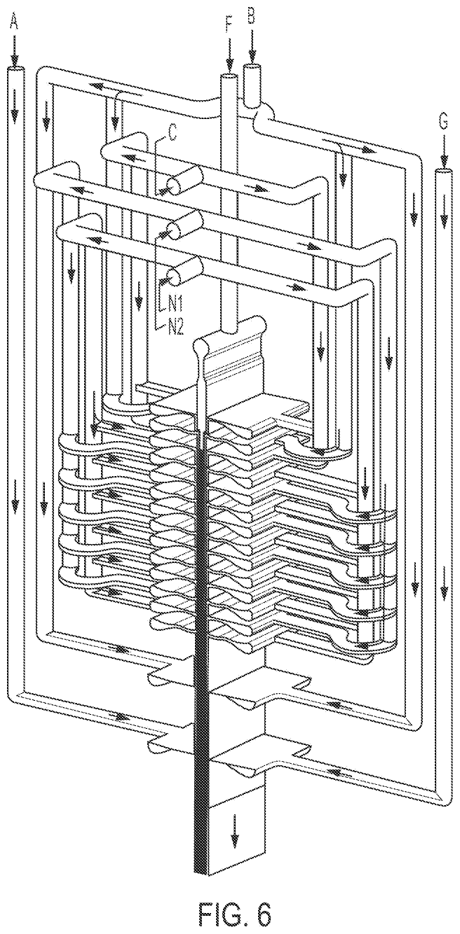

FIG. 5 shows production of a five layer film. The process requires three extruders but ultimately generates a film with five layers. As seen in FIG. 5, melted resin A/E forms the two outermost layers (A/E), melted resin B/D forms the two next inner layers (B/D), while resin C forms the core layer. As seen in FIG. 6, source material A, B, C, F, G, N1, and N2 are melted and respectively branched into multiple layers.

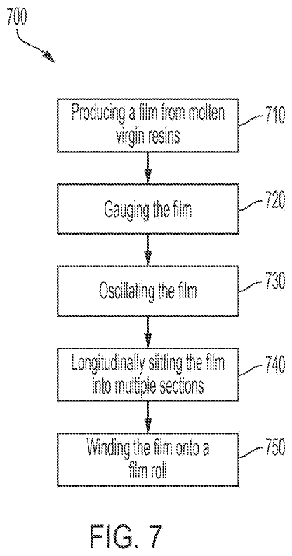

Referring generally to FIG. 7, the steps 700 are shown for producing a cast stretch film according to one embodiment. Specifically, the steps comprise producing a film from molten resins 710, gauging the film 720, oscillating the film 730, longitudinally slitting the film into multiple sections 740, and winding the film onto a film roll 750. In some embodiments, all of the steps are performed along a single production line. However, it is also contemplated that the steps can be performed in a different order, and steps may be added or eliminated without departing from the scope of the embodiments described herein.

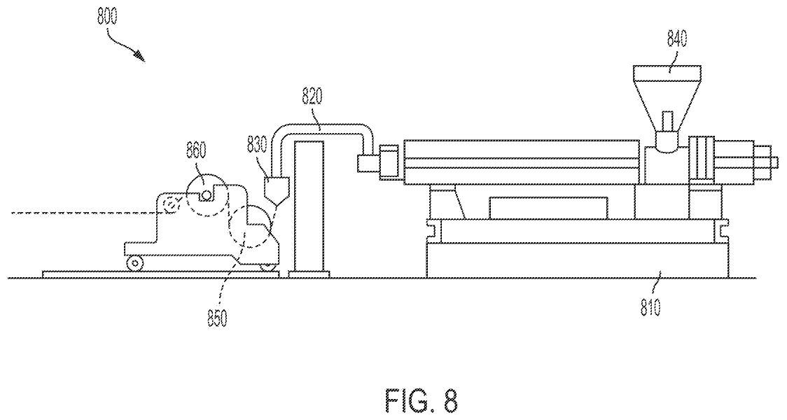

As shown in FIG. 8, a means for producing a cast stretch film from molten resins 800 comprises one or more extruders 810 connected by transfer pipes 820 to a die 830. The number of extruders 810 used in the apparatus depends upon the desired composition of the film.

For example, to produce a three-layer film, three extruders 810 are used. In another example embodiment, to produce a five-layer film, three, four, or even five extruders 810 are used depending on the number of distinct source materials.

Under an embodiment, the extruders 810 are connected to a source 840 of stock resin. The extruders 810 heat the stock resin to a molten state and deliver the molten resin to the die 830 through the transfer pipes 820. In example embodiments, the film is extruded through the die 230 onto a casting roll 250. In further example embodiments, the casting roll 250 is 25-50 inch range casting roll having a set temperature. In still further example embodiments, the set temperature of the casting roll ranges from about 75° F. to 100° F.; in an embodiment the casting roll has a set temperature of about 90° F.

In example embodiments, the film moves from the casting roll 850 to a secondary chill roll 860. According to example embodiments, the secondary chill roll is 15-30 inch secondary chill roll with a set temperature. As a further example embodiment, the set temperature of the secondary chill roll ranges from about 65° F. to 90° F., with a preferred value of about 85° F.

In some embodiments, the film is then passed from the caster roll or the chill roll to a slitting assembly. Since slitting assemblies are used to slit the film into multiple sections, for example, into one or more interior slit sections and one or more exterior slit sections.

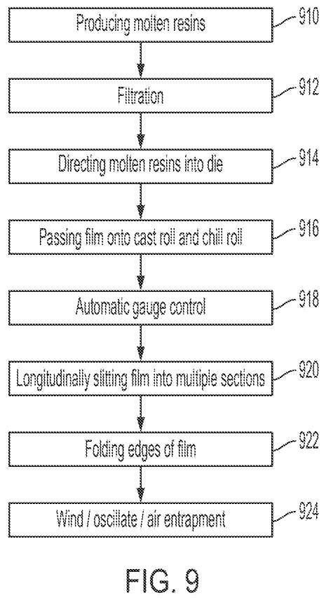

FIG. 9 shows a means for producing a film which includes the steps of slitting, in-line folding, and winding/oscillation/air entrapment as part of one continuous and uninterrupted in-line process. FIG. 9 illustrates the steps 900 for producing plastic films in-line via a continuous process, under an embodiment. FIG. 9 illustrates production molten resins 910 using one or more extruders. The process of coextrusion is described in detail above. FIG. 9 identifies a step of filtering the molten resins 912. A continuous filter may be used, under an embodiment. The molten resins are then directed in to a die 914. Film exiting the die are directed to a cast and chill roll 916.

The thickness of the film may be determined by the diameter and angular speed of the cast and chill rolls. An automatic gauge control process 918 monitors thickness of the film and provides feedback to the cast and chill roll mechanism in order to control, adjust, and maintain target thickness in real time. The process then longitudinally slits 920 the film into a plurality of sections and folds 922 edges of the film. As seen in FIG. 9, the process then implements a winding/oscillation/air entrapment 924 process. This step prevents stacking of the edge folds and entraps air between the layers of film. All of the steps may be performed in-process along a single production line. The steps may be performed in a different order, and one or more steps may be eliminated, under alternative embodiments.

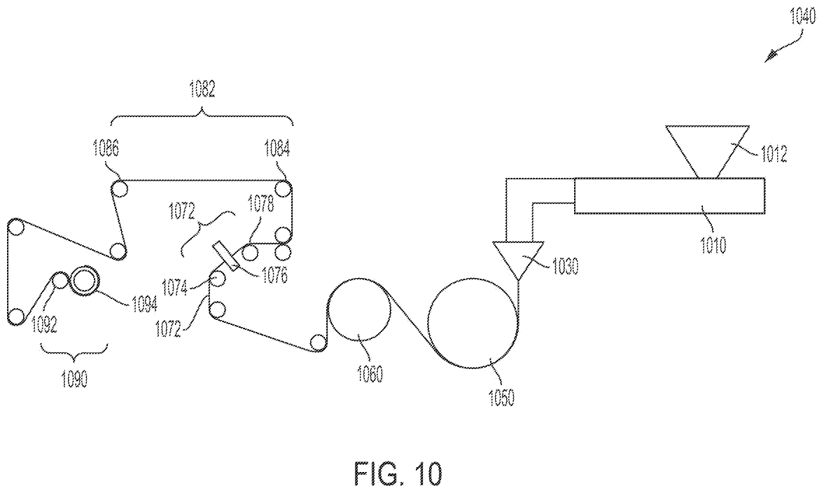

Under one embodiment (and as described above), a continuous in-line film process includes coextrusion, slitting, in-line folding, and winding/oscillation/air entrapment. FIG. 10 provides a stylized side view of a coextrusion line implementing this continuous in-line process. FIG. 10 illustrates a process for producing a cast stretch film from molten resins 1000. The process comprises one or more extruders 1010 connected by transfer pipes 1020 to a die 1030. The number of extruders 1010 used in the apparatus depends upon the desired composition of the film. Note that extruders include a filtration system. A filtration system may comprise discontinuous of continuous filtration (as described in detail below).

For example, to produce a three-layer film from three distinct source materials, three extruders 1010 are used. In another example embodiment, to produce a five-layer film, three, four, or even five extruders 1010 are used depending on the number of distinct source materials.

According to other example embodiments, the extruders 1010 are connected to a source 1040 of stock resin. The extruders 1010 heat the stock resin to a molten state and deliver the molten resin to the die 1030 through the transfer pipes 1020. In example embodiments, the film is extruded through the die 1030 onto a casting roll 1050. In further example embodiments, the casting roll 250 is a 25-30 inch diameter casting roll having a set temperature. In still further example embodiments, the set temperature of the casting roll ranges from about 75° F. to 100° F.; in a presently preferred embodiment the casting roll has a set temperature of about 90° F.

In example embodiments, the film moves from the casting roll 1050 to a secondary chill roll 1060. According to example embodiments, the secondary chill roll is a 15-30 inch diameter secondary chill roll with a set temperature. As a further example embodiment, the set temperature of the secondary chill roll ranges from about 65° F. to 90° F., with a preferred value of about 85° F.

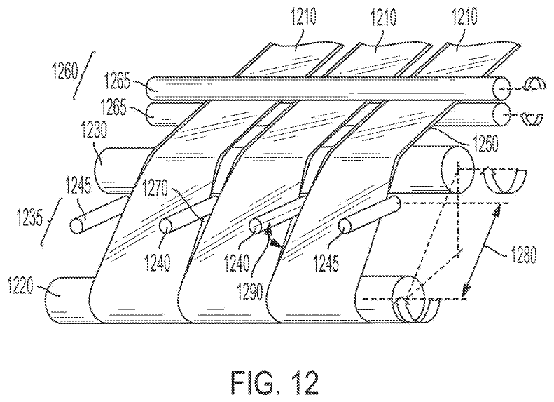

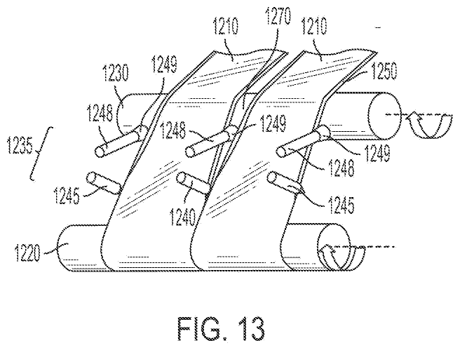

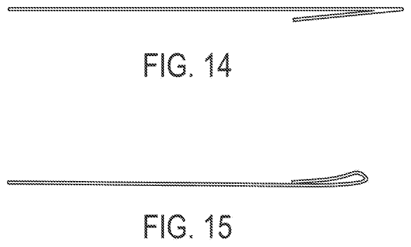

Under an embodiment, the film is then passed from the caster roll or the chill roll to a slitting assembly 1072. Since slitting assemblies are used to slit the film into multiple sections, for example, into one or more interior slit sections and one or more exterior slit sections. The film is then passed through a folding guides step 1072 comprising a roller 1074, one or more folding guide assemblies 1076, then another roller 1078. Under an embodiment, the film passes directly from roller 1074 to folding guide assemblies 1076 and then directly to the following roller 1078. This folding guide step is described in detail below in FIGS. 12-13 and corresponding disclosure. (The rollers 1074, 1078 and folding guide assembly 1076 corresponds to rollers 1220, 1230 and folding guide assembly 1235). The film then passes through a nip roll 1080 (corresponding to nip roll 1260). The process then oscillates the film using an oscillating mechanism 1082 comprising components 1084 and 1086. Under an embodiment, components 1084 and 1086 comprise parallel rollers. The rollers rotate in tandem (and along a common plane defined by the parallel longitudinal axes of the rollers) to a degree that causes a reciprocating lateral shift of the film in its path across and beyond the rollers, i.e. that causes lateral oscillation of the film. The process then implements winding and air entrapment 1090 using a retractable roll 1092 and film roll 1094. This winding and air entrapment process is described in detail below in FIG. 14 and corresponding disclosure. (The retractable roll 1092 and film roll 1094 correspond to retractable roll 1810 and film roll 1820).

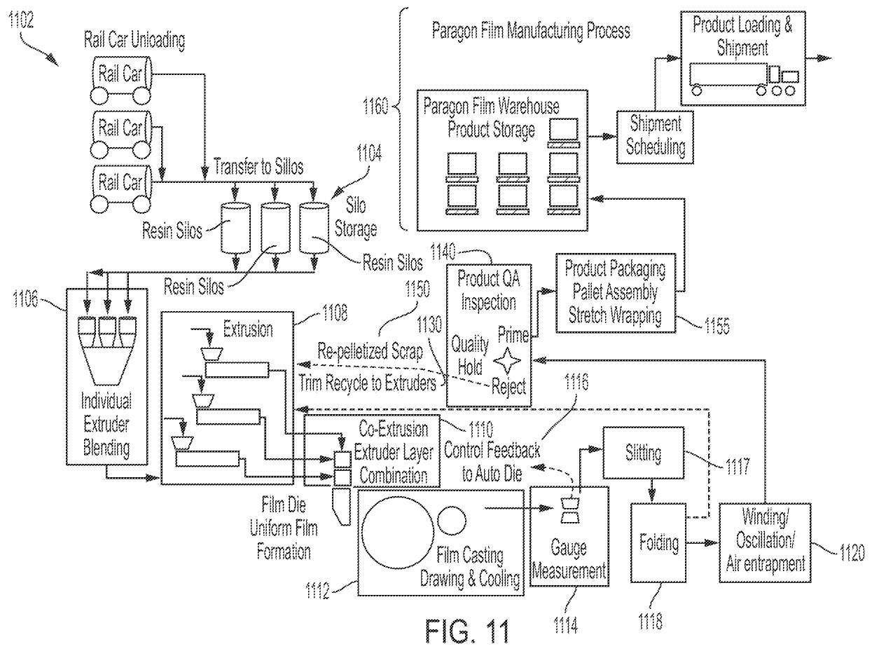

FIG. 11 provides an overview of a plastic film coextrusion process producing an embodiment of a below referenced five layer film, under an embodiment. (Note that the overall process may also simply be referred to as an extrusion line). The process begins in sourcing the ingredients. As an example, and as detailed above, a manufacturing facility receives the plastics materials via rail car 1102 (or other means). Under an embodiment, materials are sourced to produce a five layer film (as described below). The materials include LLDPE Octene 1 MI and density 0.920, metallocene HPP or RCPP or mPP 9 MFR and density 0.900, and mLLDPE Octene 4 MI and density 0.918 but embodiments are not so limited. (Formulations of a film using these three resin ingredients are described in detail below under multiple embodiments. Of course, the extrusion line may be used with any number of source materials under alternative embodiments). The three ingredients may be delivered in pellet form ready for a coextrusion process. The materials are stored in resin silos 1104, under an embodiment. Thereafter, the materials are transferred to hoppers 1106 that feed extruders 1108. The three ingredients may be used to generate a five layer film comprising a formulation and composition as described in detail below. The extruders transition the materials from a solid state to a molten resin state and pass the resins through a die 1110 which then outputs a film in five layers. (Under an embodiment two of the extruders each produce two layers of the five layer film but embodiments may include any number of extruders each of which may produce any number of layers depending upon the specific formulation and number of source ingredients).

The film is then passed to a film casting drawing and cooling process 1112. An automated gauge measurement component 1114 iteratively scans the entire breadth of the film along a laterally reciprocating path. The measurements are fed 1116 back to the die in a control feedback loop. The feedback allows the die to adjust the coextrusion layer combination in order to maintain consistent film thickness. An integral part of the overall extrusion line process then slits 1117 the film into separate longitudinally divided sections. The edges of the film may then be folded 1118 (as described in detail below) immediately after the film is longitudinally slit into sections, under an embodiment. The process then implements a winding/oscillation/air entrapment 1120 process (as described in detail below).

The slitting process may generate trim material which is then recycled, i.e. fed 1130 back to the extruders for integration back into source material. The final product (film rolls) are then held for quality insurance 1140 purposes. Film that fails quality assurance inspection is then converted to re-pelletized scrap 1150 which may then be recycled back into source material, under an embodiment. The final product is then wrapped on-site 1155 or forwarded to warehouse storage 1160 for subsequent shipping to customers.

As a precursor to a folding process, a slitting assembly may slit the film into one or more longitudinally divided section. Slitting assemblies may be used to slit the film into multiple sections. An interior slit may be defined as a slit made somewhere within the original width of film, resulting in multiple sections of lesser width. Each interior slit may require only one folding guide assembly to accommodate both adjacent film edges. An exterior slit may be defined as a slit made along one of the edges of the original width of film. Each exterior edge may require a separate folding guide assembly.

As shown in FIG. 12, the edges of the film may be folded immediately after the film is longitudinally slit into multiple sections, under an embodiment. The method for folding the edges of the film 1210 comprises a first roller 1220, a second roller 1230, and a plurality of folding guide assemblies 1235 also known as folding guides, placed between the first roller 1220 and the second roller 1230. Each folding guide assembly 1235 may be comprised of steel, aluminum, nylon, or any other material of sufficient modulus to be able to maintain rigidity with no one material demonstrating an advantage. Each folding guide assembly may also have a coefficient of friction that allows the edge of the film to turn back on itself, thus introducing a fold. The diameter and placement of the folding guide assemblies 1235 may be key factors in achieving and maintaining edge folds 1250 without roping or wrinkling of the film 1210.

The folding guide assemblies 1235 may be comprised of a plurality of folding rods 1240-1245, which may be placed in the slits 1270 between sections of film 1210 to separate the sections of film 1210. After the sections of film 1210 are separated, the cling agent and the tension of the film 1210 may cause the edge folds 1250 to form spontaneously. Each interior folding rod 1240 may produce two edge folds 1250, while each exterior folding rod 1245 may produce one edge fold 1250.

The folding rods 1240-1245 may vary from ⅜ inch to 1 inch in diameter, with a preferred diameter of approximately 11/16 inch. The folding rods 1240-1245 may have uniform diameter throughout their length. As an alternative, the portions of the folding rods 1240-1245 that contact the film 1210 may have a smaller diameter or narrow to a point to further aid in separating the sections of film 1210.

The folding rods 1240-1245 may be placed in the slits 1270 between sections of the film 1210 at a guide distance 1280 and a guide angle 1290. The guide distance 1280 may be approximately ⅔ of the distance between the first roller 1220 and the second roller 1230, as measured from the point where the film 1210 leaves the first roller 1220 to the point where the film 1210 first contacts the folding rods 1240-1245. The guide angle 1290 between the film 1210 and the folding rods 1240-1245, measured with the folding rods 1240-1245 leaning toward the first roller 1220, may vary from 20° to 90°, with a preferred angle of approximately 45°.

As shown in FIG. 13, the folding guide assemblies 1235 may also be comprised of a plurality of folding rods 1240-1245 and a plurality of re-folders 1248. Each folding rod 1240-1245 and each re-folder 1248 may be separate units that can be positioned independently. Alternatively, each folding rod 1240-1245 and each re-folder 1248 may be combined into a single unit. If the folding rod 1240-1245 and re-folder 1248 are combined into a single unit, their positions may be fixed or adjustable relative to each other.

The re-folders 1248 may be placed in the slits 1270 between sections (or at an outer edge) of the film 1210 after the folding rods 1240-1245 and before the second roller 1230. The re-folders 1248 may function to further separate the sections of film 1210 and to direct the film 1210 back onto itself at an angle that aids in re-establishing folds 1250 that are lost during the production process. Causes of lost folds 1250 include, but are not limited to, holes, gels, contaminated resins, flaws in the film, and other production problems.

The composition and diameter of the re-folders 1248 may be comparable to that of the folding rods 1240-1245. The re-folders 1248 may have uniform diameter throughout their length. However, as shown in FIG. 13, the portions 1249 of the re-folders 1248 that contact the film 1210 may be wider than the other portions of the re-folders 1248 in order to increase the amount of separation between adjacent sections of the film 1210. For example, the portions 1249 of the re-folders 1248 that contact the film 1210 may be capped by an inverted cone or sphere.

As shown in FIG. 12, the means for folding the edges of the film 1210 may also comprise a nip roll assembly 1260. The nip roll assembly 1260 may consist of two rollers 1265 pressed together, and may be primarily intended to control the tension of the film 1210 as it passes through the slitting assembly and the edge folding apparatus. The nip roll assembly 1260 may also aid in pressing the folds 1250 into the film 1210, resulting in flat edge folds as shown in FIG. 14. If the nip roll assembly 1260 is not employed, air entrapment may occur within the edge folds as shown in FIG. 15. Air entrapment within the edge folds may result in a film roll with a different appearance and functionality, much like having bubble wrap on the ends of the roll.

The edge folds described above make the film less susceptible to failure due to tears, rough handling, dropping, or excessive stretching. Thus, the ability to introduce and maintain edge folds is a key component of film performance. Film failures caused by gels are highly dependent on location of the gel. Non-folded film is more susceptible to catastrophic tearing if a gel is located on the edge. Folded edge film mitigates this risk.

The film may be oscillated and wound onto film rolls after the edges of the film are folded. The present disclosure may use any conventional oscillating mechanism to oscillate the film. For example, the oscillating mechanism may be a frame that moves back and forth across a set distance in a controlled manner at a specified rate. The film may be supported by and move with the oscillating frame.

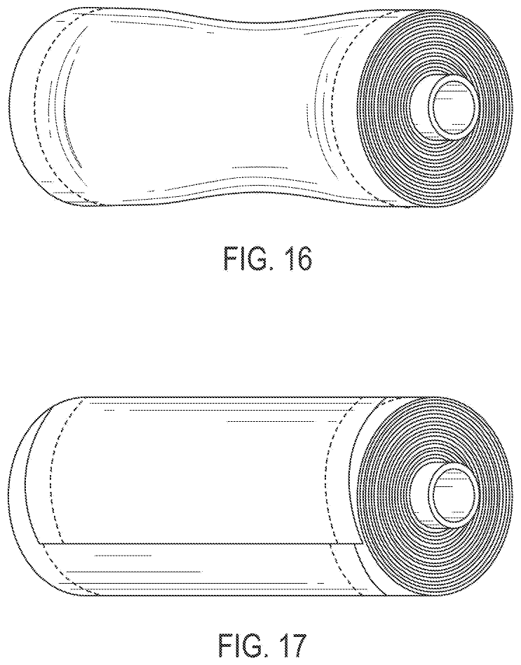

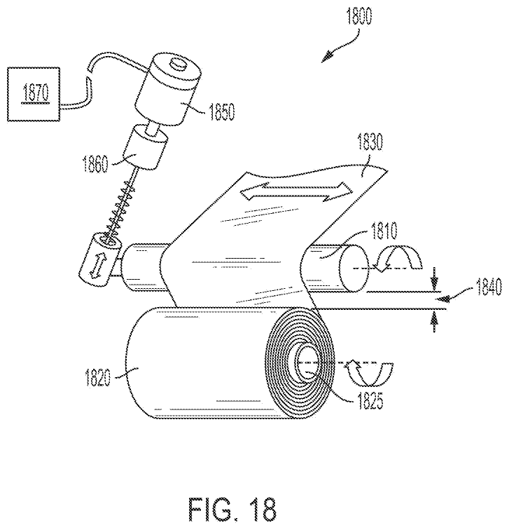

Oscillation may efficiently distribute the edge folds onto the film roll. If the film is not oscillated, the edge folds will stack up in one location, producing a film roll with hard, raised edges as shown in FIG. 16. The hard, raised edges are susceptible to damage and prevent the film from unwinding properly, resulting in film rolls that are unusable. In contrast, oscillation produces film rolls that are generally uniform, as shown in FIG. 17, and easy to unwind.

To prevent the edge folds from stacking up, the film may be oscillated for a distance that is greater than the combined width of the edge folds. For example, if each edge fold is approximately ¼ inch, the film may be oscillated approximately ⅝ inch to prevent stacking. The oscillation rate may range from 1 to 20 cycles per minute, with a preferred rate of approximately 7.5 cycles per minute.

Entrapping air between the layers of film as the film is wound onto a film roll also makes the film easier to unwind and less susceptible to damage. As shown in FIG. 18, the winding mechanism 1800 may be comprised of a retractable roll 1810 and a film roll 1820. The film roll 1820 may begin as a core 1825 onto which the film 1830 is wound and may gradually increase in size as multiple layers of film 1830 are wrapped around the core 1825.

The film 1830 may pass over the retractable roller 1810, which moves away from the film roll 1820 at a separation rate as the film roll 1820 increases in size. The separation rate may maintain a constant distance between the retractable roller 1810 and the surface of the film roll 1820, described as an air gap 1840. The air gap 1840 may be consistently maintained throughout the winding process in order to trap air between the layers of film 1830 as they are wound onto the film roll 1820. The air gap 1840 may be relatively short in order to maintain the appropriate level of air entrapment and to ensure proper oscillation of the film 1830. For example, the air gap 1840 may range from 0 to 5 inches, with a preferred distance of approximately one inch.

A mechanical system may be used to control the retractable roller 1810. The types of mechanical systems that may be used include, but are not limited to, motor driven jack screw assemblies 1850-1860, linear actuators, cams, pneumatically driven systems, and hydraulically driven systems. The mechanical system may be operated and controlled by any conventional method, including, but not limited to, a programmable logic control (PLC) system 1870 located within the winding mechanism 1800.

The in-line process described with respect to FIGS. 9-18 may be used to produce a film comprising five layers, under an embodiment. These five layers may comprise a combination of resins as described below (but embodiments are not so limited).

There are two types of resins often used in stretch film, cast film, or otherwise plastic films—Polyethylene and Polypropylene. Polyethylene is derived from an ethylene molecule while polypropylene is derived from propylene. (Additional resins and combinations thereof may be used under differing embodiments).

Polyethylene consists of hydrocarbon chains with the most basic component being the ethylene molecule, consisting of 2 carbon and 4 hydrogen atoms. When ethylene molecules are combined together in straight or branched chains, polyethylene is formed. This process involves splitting the double bond between the 2 carbon atoms and creating a free radical to join to the next ethylene molecule. Polyethylene is generally categorized by Density. High Density (above 0.940 g/cm³), Low Density (below 0.930 g/cm³), Linear Low Density (below 0.930 g/cm³ and a co-monomer) are the most common types, called HDPE, LDPE, LLDPE for short.

LLDPE is categorized differently from LDPE due to its makeup of what is called Co-Monomers. Basically, this process includes adding another type of molecule to the chain besides Ethylene. In particular, LLDPE is a copolymer of ethylene and another longer olefin, which is incorporated to improve properties such as tensile strength or resistance to harsh environments. These α-olefins include 1-butene, 1-hexene, 4-methyl-1-pentene and 1-octene. Linear low density polyethylene (LLDPE) is characterized by short, random chain branching, with a density of 0.915 to 0.930 g/cc³.

The melt index of LLDPE is a measure of the ease of flow of the melt of a thermoplastic polymer. It is defined as the mass of a polymer, in grams, flowing in ten minutes. For LLDPE, the measure comprises g/10 min at 190 degrees (according to ASTM D1238 @ 190 C). Melt index also determines properties of LLDPE. In fact, Density and Melt Index generally define characteristics of LLDPE (among other factors). These characteristics are set forth in Table I below.

TABLE 1
General Guide to the Effects of Melt Index and Density
on Mechanical Properties and Processing of LLDPE

| | As Melt Index | As Density |
|---|---|---|
| Characteristic | Increases | Increases |
| Chemical Resistance | Stays the Same | Increases |
| Clarity | Increases | Increases |
| Elongation at Rupture | Decreases | Decreases |
| Extrusion Speed | Increases | Increases |
| Drawdown | Increases | Increases |
| Flexibility | Stays the Same | Decreases |
| Gloss | Increases | Stays the Same |
| Heat Resistance (softening point) | Stays the Same | Increases |
| Impermeability to Gases/Liquids | Stays the Same | Increases |
| Low Temperature Flexibility | Decreases | Decreases |
| Melt Viscosity | Decreases | Increases |
| Mechanical Flex Life | Decreases | Decreases |
| Stress Crack Resistance | Decreases | Decreases |
| Tensile Strength at Break | Decreases | Increases |
| Resistance to Blocking | Decreases | Increases |
| Stress Cracking Resistance | Decreases | Decreases |
| Tensile Strength at Rupture | Decreases | Increases |

Of course, the co-monomer itself also defines the properties of a film as described below:

Butene LLDPE
Tear and puncture performance is poor

Hexene LLDPE
Moderate to good tear and puncture performance

Octene LLDPE
Typically tougher than hexenes of the same melt index and density (meaning better tear and puncture performance over hexene)

In addition to the Co-Monomer classification, there is also catalyst classification or a “how it's made” classification. Catalyst type is used to describe a process type, not ingredient. Catalysts may be used to change how the product is made with Ethylene and a Co-Monomer. Ethylene and Co-Monomers are generally all considered equal, it's the catalyst that changes the film. Common catalyst categories are Ziegler-Natta (common medium grade) and Metallocene (Premium grade). Each type of LLDPE (i.e., Butene, Octene, Hexene, and Methyl Pentene LLDPE) are generated using a Ziegler-Natta catalyst, under an embodiment. In fact, reference to LLDPE generally (and herein unless the context indicates otherwise) indicates use of a Ziegler-Natta catalyst. In contrast Metallocene catalyst may be used to generated a metallocene LLDPEs generally referred to as mLLPDE. Metallocene polyethylene, also known as mPE or mLLDPE, is a single site catalyzed LLDPE, which results in a more uniform material. mPE typically has a very even chain branching. Its density ranges from 0.870 to 0.965 g/cc³. Note that an mLLDPE may comprise mLLDPE hexene, mLLDPE Butene, or mLLDPE Octene.

Polypropylene is a thermoplastic resin built up by the polymerization of the propylene monomer. Polypropylene is a tough, rigid, and crystalline thermoplastic. Polypropylene comes either as homopolymer or as copolymer. Note that the Melt Flow Rate (or MFR and similar to Melt Index) is a measure of the ease of flow of the melt of a polypropylene. It is defined as the mass of a polypropylene, in grams, flowing in ten minutes. MFR comprises g/10 min at 230 degrees (according to ASTM D1238 @ 230 C).

Polypropylene homopolymers (HPP) are thermoplastic resins produced through the polymerization of propylene. The use of metallocene catalysts in the production of HPP results in resins (referred to as mHPP) with the following property: High cross directional tear resistance.

A random copolymer is one in which monomer residues are located randomly in the polymer molecule. Polypropylene random copolymers are thermoplastic resins produced through the polymerization of propylene, with ethylene bonds introduced in the polymer chain. The resins provide a broad range of characteristics, and are used in a wide range of applications. Accordingly, Random Copolymer Polypropylene (RCPP) comprises a polypropylene copolymer containing a Small (2-6% by weight) amount of ethylene.

A Metallocene copolymer is one in which monomer residues are located uniformly throughout the polymer molecule. Polypropylene copolymers are thermoplastic resins produced through the polymerization of propylene, with ethylene bonds introduced in the polymer chain. The resins provide a broad range of characteristics, and are used in a wide range of applications. Accordingly, Metallocene Polypropylene (mPP) comprises a polypropylene copolymer containing a Small (0.05/6-3% by weight) amount of ethylene. The use of metallocene catalysts in the production of PP results in resins (referred to as mPP) with the following properties: High cross directional tear strength with improved compatibility with PE and reduction of strain whitening.

Under an embodiment, a five layer film is produced by the in-line methods described herein (see FIGS. 7-8 and FIGS. 9-18). The three components of the five layer film comprise the following:
1. LLDPE Octene 1MI Subskin (36% for each subskin measured by weight pre melt; alternatively each subskin may comprise 15-40% measured by weight pre melt with each subskin comprising an equal percentage within this range but embodiments are not so limited to equal percentages)
   Range of MI from 0.5 to 2
   Actual density 0.920
   Range of Density from 0.916-0.922
2. Metallocene homopolymer polypropylene (mHPP) core (12% by weight measured pre melt; the core may comprise 5-20% measured by weight pre melt) MFR (similar to MI) of 9. Range of 5-20 MFR
   Actual Density 0.900
   Range of 0.870 to 0.915
3. Metallocene LLDPE Octene (mLLDPE octene) 4MI Skin (8% by weight measure pre melt; alternatively each skin may comprise 5-15% measured by weight pre melt with each skin comprising an equal percentage within this range but embodiments are not so limited to equal percentages)
   Range of MI 3-5
   Actual density 0.918
   Range of density 0.916-0.922
      Under the embodiment described immediately above, the five-layer film comprises a two layer mLLDPE Octene Skin, a mHPP core, and a LLDPE Octene Subskin. In other words, the mLLDPE Octene Skin comprises two outer skin layers, the LLDPE Octene Subskin comprises the two next inwardly successive subskin layers, and the mHPP core comprises a core layer between the subskin layers.

Under an embodiment, a five layer film is produced by the in-line methods described herein (see FIGS. 7-8 and FIGS. 9-18). The three components of the five layer film comprise the following:
1. LLDPE Octene 1MI Subskin (36% for each subskin measured by weight pre melt; alternatively each subskin may comprise 15-40% measured by weight pre melt with each subskin comprising an equal percentage within this range but embodiments are not so limited to equal percentages)
   Range of MI from 0.5 to 2
   Actual density 0.920
   Range of Density from 0.916-0.922
2. Random copolymer polypropylene (RCPP) core (12% by weight measured pre melt; the core may comprise 5-20% measured by weight pre melt)
   MFR (similar to MI) of 9. Range of 5-20 MFR
   Actual Density 0.900
   Range of 0.870 to 0.910
3. Metallocene LLDPE Octene (mLLDPE octene) 4MI Skin (8% by weight measured pre melt; alternatively each skin may comprise 5-15% measured by weight pre melt with each skin comprising an equal percentage within this range but embodiments are not so limited to equal percentages)
   Range of MI 3-5
   Actual density 0.918
   Range of density 0.916-0.922
      Under the embodiment described immediately above, the five layer film comprises a two layer mLLDPE Octene Skin, a RCPP core, and a LLDPE Octene Subskin. In other words, the mLLDPE Octene Skin comprises two outer skin layers, the LLDPE Octene Subskin comprises the two next inwardly successive subskin layers, and the RCPP core comprises a core layer between the subskin layers.

Under an embodiment, a five layer film is produced by the in-line methods described herein (see FIGS. 7-8 and FIGS. 9-18). The three components of the five layer film comprise the following:
1. LLDPE Octene 1MI Subskin (36% for each subskin measured by weight pre melt; alternatively each subskin may comprise 15-40% measured by weight pre melt with each subskin comprising an equal percentage within this range but embodiments are not so limited to equal percentages)
   a. Range of MI from 0.5 to 2
   b. Actual density 0.920
   c. Range of Density from 0.916-0.922
2. Metallocene polypropylene (mPP) core (12% by weight measured pre melt; the core may comprise 5-20% measured by weight pre melt)
   a. MFR (similar to MI) of 9. Range of 5-20 MFR
   b. Actual Density 0.900
   c. Range of 0.870 to 0.915
3. Metallocene LLDPE Octene (mLLDPE octene) 4MI Skin (8% by weight measured pre melt; alternatively each skin may comprise 5-15% measured by weight pre melt with each skin comprising an equal percentage within this range but embodiments are not so limited to equal percentages)
   a. Range of MI 3-5
   b. Actual density 0.918
   c. Range of density 0.916-0.922
      Under the embodiment described immediately above, the five-layer film comprises a two layer mLLDPE Octene Skin, a mPP core, and a LLDPE Octene Subskin. In other words, the mLLDPE Octene Skin comprises two outer skin layers, the LLDPE Octene Subskin comprises the two next inwardly successive subskin layers, and the mPP core comprises a core layer between the subskin layers.

Under an embodiment, the five layer film (as described above) may comprises six (6) microns or less.

Under an alternative embodiment, one or more of the source materials (and corresponding layers) may be incorporated into films of additional or fewer layers, wherein the one or more source materials (and corresponding layers) may comprise the same or differing parameters and/or ranges of parameters, e.g. MI/MFR, density, % by weight, etc.

Primary and Secondary Anti-Oxidants may be added to LLDPE. Primary are typically Phenolics, Secondary are typically Phosphites.

Under an embodiment, a five layer film is produced by the in-line methods described herein (see FIGS. 7-8 and FIGS. 9-18). The components of the five layer film comprise the following resins:

1. LLDPE Butene 2MI Skin (8% for each skin measured by weight pre melt; alternatively the subskins may comprise 5-50% measured by weight pre melt with each skin comprising an equal percentage within this range but embodiments are not so limited to equal percentages)
Range of MI from 1 to 3
Actual density 0.919
Range of Density from 0.915-0.925
Melting Point of 121 C
Melting Point Range of 110 C to 130 C
   Each skin may comprise one of the following additives

Liquid Injected Polyisobutlyene

Cling Agent Additive (ranges of properties listed below in parenthesis)
0.89 density (0.87-0.93 density)
Molecular Weight 2800 (750-3,000)
   Kinematic Viscosity at 100c=3,121 cSt (86-4000) Polyolefin Plastomer

Cling Agent Additive (ranges of properties listed below in parenthesis)
0.875 Density (0.85-0.920)
3 MI (1-5)
   Under an embodiment, the skin layers may comprise one of the following resin components:

LLDPE Hexene (ranges of properties listed below in parenthesis)
3 MI (1-5)
S 0.919 density (0.912-0.925)
Melting point of 120 C (110-130)

mLLDPE Hexene (ranges of properties listed below in parenthesis)
3.5 MI (1-5)
0.918 Density (0.911-0.925)
Melting point 119 C (110-130)

mLLDPE Octene (ranges of properties listed below in parenthesis)
4.0 MI (1-5)
0.918 Density (0.911-0.925)
Melting point 119 C (110-130)
   Under various embodiments, each skin layer may separately comprise any one of the above referenced components (LLDPE Butene, LLDPE Hexene, mLLDPE Hexene, or mLLDPE Octene) under the properties and ranges listed above for each component. And each skin layer may then also comprise one or both additives.
   2. LLDPE Hexene 1MI Subskin and Core (11.33% for each subskin layer and core layer measured by weight pre melt; alternatively the subskin and core layers may comprise 10-90% measured by weight pre melt with each subskin layer and core layer comprising an equal percentage within this range but embodiments are not so limited to equal percentages)
Range of MI from 1 to 5
Actual density 0.919
Range of Density from 0.912-0.925
Melting Point of 120 C
Melting Point Range of 110 C to 130 C

A first LLDPE Hexene 1MI subskin may comprise a Post Consumer Recycled (PCR) Resin (ranges of properties listed below in parenthesis)
25% of total structure by weight pre-melt (5%-75%)
2 MI (0.1-5)
0.919 Density (0.910-0.930)
PCR may comprise any one or combination of LLDPEs (of any type) and LDPEs (of any type)
   PCR plastics include plastics that have been used for their intended purpose at one point.

A second LLDPE Hexene 1MI subskin may comprise a Post Industrial Recycled (PIR). Resin (ranges of properties listed below in parenthesis)
25% of total structure by weight (5%-75%)
2 MI (0.1-5)
0.919 Density (0.910-0.930)
PIR comprises any one or combination of LLDPEs (of any type)
   PIR plastics are plastics that have not been used for their intended purpose, but have been through an industrial manufacturing process already.

Under alternative embodiments, the subskin and core layers may all uniformly comprise one of the following components:

LLDPE Butene (ranges of properties listed below in parenthesis)
2 MI (1-3)
0.919 Density (0.915-0.925)
Melting Point of 121 C (110-130)

mLLDPE Hexene (ranges of properties listed below in parenthesis)
3.5 MI (1-5)
0.918 Density (0.911-0.925)
Melting point 119 C (110-130)

mLLDPE Octene (ranges of properties listed below in parenthesis)
4.0 MI (1-5)
0.918 Density (0.911-0.925)
Melting point 118 C (110-130)

Under various embodiments, the subskin and core layers may each separately comprise any one of the above referenced components (LLDPE Hexene, LLDPE Butene, mLLDPE Hexene, MLLDPE Octene) under the properties listed above for each component. And each subskin and core layer may comprise PCR and/or PIR components. Each subskin layer and core layer may comprise 11.33% measured by weight pre melt; alternatively each subskin and core layer may comprise 10-90% measured by weight pre melt with each subskin layer and core layer comprising an equal percentage within this range but embodiments are not so limited to equal percentages. Each PCR and PIR component may comprise 25% of total structure by weight; alternatively each PCR and PIR component may comprise 5%-75% measured by weight pre melt. The PCR component may be distributed in any manner across the entire set or subset of the subskin and core layers. The PIR component may be distributed in any manner across the entire set or subset of the subskin and core layers.

Under alternative embodiments, each subskin comprises two layers. In other words the subskins and core comprise the inner five layers. The same percentage of total structure by weight pre-melt as allocated above with respect to subskin and core may be allocated across the inner five layers (in either equal or unequal portions).

Under alternative embodiments, each subskin comprises 4 layers. In other words the subskins and core comprise the inner nine layers. The same percentage of total structure by weight pre-melt as allocated above with respect to subskin and core may be allocated across the inner nine layers (in either equal or unequal portions).

Under an embodiment the film described above comprises 8 microns or less.

The use of recycled resins (PIR and/or PCR) in a folded edge films has been restricted to out of line processes. The out of line process of pre-stretching then rewinding is not something that can be done due to the inherent nature of recycled resins having high amounts of contamination. High contaminates cause holes in the film and do not allow the film to be prestreched without breaking, therefore making the out of line process infeasible.

By incorporating recycled resins into folded edge films, there is a distinct advantage over the out of line process, as it is not necessary to pre-stretch the film to gain the favorable properties of an oriented film. This feature allows the film to avoid holes, as the film is not contaminated due to the presence of recycled resins since an unreinforced stretched film containing recycled resins has a higher likelihood of generating holes and having breaks.

This film is unique in its ability to utilize PCR resins that allow for improved sustainability goals for end users. In essence, the virgin plastic usage is significantly reduced by replacing virgin plastics with PCR. This improves the carbon footprint of this stretch film. PCR inherently has many contaminants due to the process of using then collecting the film to be reprocessed. Contaminants have long been cause of failure in stretch film due to creating hard spots in the film that do not stretch like the rest of the film causing holes. The utilization of continuous filtration and edge folding in process allows for downgauging stretch films to thin gauges that previously was unattainable. This allows film thicknesses to reach 8 micron or less. In use of the film, the folded edges protect the film. In addition, the folded edges provide extra strength to the film in the event a contaminant causes the film to rupture during use. The folded edges combat this by resisting tearing and preventing catastrophic failure even with high contamination rates common when producing films made with PCR.

Previous technologies used to add folds to thin gauge (8 micron and below) films involve a process of pre-stretching the film in an out of line process. This process involves reducing the gauge of a thicker film to a thin gauge and in the same process add folds. This out of line process is straining on the film. If a thicker film that is to be pre-stretched contained PCR, the contaminants may cause the thicker film to have holes and to break.

There are a number of filtration designs to consider with respect to single and co-extruded film applications. Screen changer designs fall into two basic categories: discontinuous and continuous. These category descriptions reference what happens to polymer flow when a screen change is executed. Discontinuous designs block or momentarily interrupt the flow of polymer during the screen change. The flow interruption may be as short as 1-2 seconds, or may require several minutes to change a screen, depending on design. When screens are changed in a continuous design, polymer flow to the die is not blocked. Flow will continue during the screen change process. There are two subsets in the continuous category: continuous flow and continuous flow constant. Each of these designs can also have a variant that includes automatic filter cleaning during operation. Each of these designs will be reviewed in more detail.

Before covering screen changer types, basic information about the screens and breaker plate should not be over-looked. In every screen changer, there is a filter medium. The purpose of a screen changer design is to provide containment, structural support, and efficient exchange of filter media while ensuring safe, effective filtering of contaminants.

Screens and Breaker Plates

Although a variety of filter media can be considered, most changer designs use a breaker plate to support the filter. Prevailing breaker-plate designs are round or oval in shape and have a series of holes in the plate, typically in a circular pattern. The breaker plate is designed to maximize flow, minimize pressure drop, and provide structural support for the screen pack. Although a pressure drop is created by the breaker plate, in most cases, most of the pressure drop will occur at the screen mesh.

Two of the more common screens used in film applications are square mesh and Dutch weave. The wire weave pattern for a square mesh screen has the same number of wires in the horizontal and vertical directions, with even spacing between the wires. Square-weave screens, unlike Dutch weave, normally have a higher percentage of open area, lower initial pressure drop, and are less expensive. Under high pressure, square-weave wires may be more prone to shifting, which could compromise the filter objective

Screens have a mesh and micron rating. Determining the mesh is very simple and involves simply counting how many openings there are in one linear inch of screen. A 20-mesh screen has 20 openings across one linear inch of screen. Therefore, as the mesh number increases, the size of the opening decreases. Note that mesh size is not a precise measurement of particle size because of the varying wire diameters that may be used in the screen. When selecting the appropriate screen rating, it is best to rely on the micron rating rather than the mesh rating. The micron rating of a screen defines the average size of the openings between pieces of filter media. When comparing mesh ratings from different screen manufacturers, the actual micron rating can be different from one manufacturer to another, depending on the wire diameter that is used in the screen. Dutch weave screens have a wire pattern that uses larger wire diameter in the horizontal direction and smaller diameter wire in the vertical direction. Dutch weave, compared to square weave, normally has a lower percentage of open area, a higher initial pressure drop, and is slightly more expensive. Dutch weave screens tend to be more stable at high operating pressures than square-weave screens.

Once the screen rating has been determined, efficient use of the screen is highly dependent upon screen pack construction. For example, suppose that a 150 mesh screen has been determined to be the finest screen required for a screen pack. There will not be enough screen rigidity to simply place a 150 mesh screen directly on the breaker plate. Screen dimpling or screen rupture will occur under polymer flow at normal extrusion pressures, and the outer screen diameter will reduce in size under pressure as the screen is pressed into the breaker plate holes. This will allow contaminants to flow around the screen or through the screen in the event of a hole rupture. As an example, the first screen resting against the breaker plate is typically a 10, 12, or 20 mesh screen. In this example, a 20 mesh screen is used as the base layer. From there, each successive screen layer should be three to five times the mesh value of the screen against which it will nest. A final cover screen in this example is a 20 mesh which will hold the 150 mesh screen securely in place.

Discontinuous: Manual Screen Changers

Manual screen changers are one of the simplest and most economical designs available. The screen pack and breaker plate are supported by a carrier mechanism that will enable the screen to be indexed into the online melt stream position and then removed to an offline position for screen ex-change. The carrier mechanism is either a sliding plate or a sliding piston that contains one or two breaker plate cavities depending on the configurable design. Most common are two-cavity designs. When a screen is in the online melt stream position, contaminants will be collected on the screen over time, causing the pressure before the screen, also known as head pressure, to increase. Once the head pressure reaches its predefined limit, the extrusion process must be stopped so that the head pressure can be relieved before the online screen position can be shifted offline. In a two-cavity sliding plate, for ex-ample, as the dirty screen position indexes offline, the stand-by screen is indexed online. The extrusion line can then be restarted. The indexing of the carrier mechanism is accomplished by a lever, a mechanical ratcheting device, or a hand wheel.

Manual screen changer size is defined by the breaker plate diameter. Sizes are available from 25-165 mm (1.0″-6.5″).

Discontinuous: Hydraulic Screen Changers

Similarly to the manual screen changer, the carrier mechanism for the breaker plate and screen is a sliding plate or a piston. The carrier mechanism is indexed using a hydraulic power unit. The hydraulic slide plate design will shift and exchange screen positions in approximately one second. Therefore, the extrusion line does not have to be shut down or stopped as with the manual screen changer. The “fast shift” mechanism enables the dirty screen pack to be removed from service and a clean screen pack indexed online by push-button control during the extrusion operation. Unlike the manual screen changer, where the interruption of flow can be several minutes due to line shut-down, the hydraulic slide plate design can be shifted under operating pressure during production. The shifting creates a flow interrupt and typically ingests a small amount of air into the melt stream. In most processes, the line can continue to operate with only a minimal waste yield from the screen change and reduced downtime compared to a manual screen changer. A variant of the slide plate is a piston carrier, which also uses a hydraulic power unit. Unlike the slide-plate design, pistons index at a slower speed and may require line shutdown to change the contaminated screen pack.

Hydraulic slide-plate screen changers are available in sizes from 63-380 mm (2.5″-15″). Hydraulic piston screen changers sizes range from 30-450 mm in round breaker plate designs and in oval designs up to 410 mm×580 mm.

Continuous: Piston Screen Changer

Continuous piston screen changer designs commonly use two round pistons as the breaker plate and the screen carrier. The two pistons are mounted in a forged steel block housing, where the pistons can index left or right perpendicular to the polymer flow. At the upstream entrance to the housing, the polymer flow channel diverges into two channels, advancing polymer to each screen cavity. After flowing through the breaker plates, the polymer channels unite to a single flow bore upon exiting the screen changer.

In normal operation, both breaker plates are online in the melt stream. When a screen changer is required, the appropriate screen piston is hydraulically moved out of the housing until the screen cavity is accessible. The contaminated screen pack can be removed and replaced with a clean screen pack. Afterwards, the piston automatically indexes the clean screen cavity into the housing. Before the screen cavity enters the melt stream, the piston stops at the point where a prefill grove in the piston intersects the melt stream. This allows polymer, at a precisely controlled rate, to fill the screen cavity and purge any air. Once the screen cavity has completed the purge step, it indexes back into the online position. The second dirty screen will then be changed in the same manner.

Piston screen changers have a number of configurable options offering different degrees of performance capability based on the application need. Depending on the amount of filtration area required, each piston can have either one or two screen cavities. Four-cavity machines provide double the filtration area in a more compact machine size versus a larger two-cavity machine of equivalent area. As well, four-cavity machines offer very stable process pressure because 75% of the filtration area remains online in production during a screen change.

Backflushing Options are available for both two- and four-cavity screen changers where moderate to high contamination levels exist in the melt stream. Backflush is a method of automatically purging and removing contaminants from a dirty screen so that the screen pack can be reused multiple times within the machine before being discarded and replaced. The number of times that a screen can be back-flushed varies by application, but on average, manufacturers indicate that backflushing can be done 50-100 times before screen replacement. By extending usable screen life, significant operating cost savings can be achieved, as well as reduced labor intervention for screen changes.

Power Backflush machines can isolate the backflushing process of a screen, use com-pressed polymer under high pressure to improve filter cleaning, and further extend filter life while providing uniform pressure and flow to the die. Power backflush options can nearly double the number of times that a screen can be backflushed. The power backflush design delivers stable, consistent process pressure and can be used in applications where there is not enough downstream pressure for conventional backflush screen changers. Although capital investment for this machine is higher, there can be large savings in screen cost, reduced labor, and waste reduction, yielding attractive returns on investment.

Expanding filtration area without expanding overall machine size is a cost and space benefit. New filter designs for piston-activated screen changers substantially enlarge available filtration area without the need to increase machine size, enabling processors of low- to medium-viscosity polymers to achieve finer filtration, higher throughputs, longer filter service life, and less material waste when backflushing. The filters contain a filter stack made up of two to four discs depending on machine size. Each disc is equipped with two screen packs per piston cavity. As a result, four to eight times more filtration area is available for each cavity than with standard round screens, depending on machine size.

Continuous: Rotary Screen Changer

The continuous rotary screen changer uses a round wheel as the carrier mechanism for the breaker plates and screens. It is essentially a round sliding plate located within a housing. Kidney-shaped breaker plates are housed in the wheel carrier, and the round sliding plate has a geared outer diameter that is used for mechanical rotation. By using the kidney-shaped breaker plate and screen, one or two screens can be intersecting the melt bore at one time. Therefore, there is minimal mechanical interference in polymer flow during screen-to-screen transitions. A sophisticated controller measures head pressure, and a feedback circuit adjusts the slide-plate indexing speed to maintain a relatively constant head pressure.

Effective sealing is dependent on body bolts that are torqued to a precise value for a given melt pressure and polymer viscosity while not limiting the sliding plate's rotation. Precision machining of the sliding plate and housing sealing surfaces is required for effective sealing. Of the screen changers reviewed in this chapter, the capital investment for the rotary wheel design will typically be the highest for equivalently sized machines.

Continuous Belt Screen Changer

The belt design screen changer uses a long continuous roll of Dutch-weave filter medium that is supported in the melt stream by a breaker plate. The filter roll indexes across the melt stream as contaminants collect on the screen at a rate that provides continuous flow and relatively constant pressure.

Screens index through an entry and exit groove in the screen changer housing, enabling them to move in the transverse direction across the melt stream. Belt indexing is controlled using a series of heating and cooling zones on the entry and exit path of the belt. When the zones are heated, an intentional leak path to atmosphere is created, and the head pressure within the melt chamber will force the screen to index in the direction of polymer plug leakage. As a new clean screen moves online, head pressure declines. A closed loop controller monitoring head pressure will then eliminate the heat source to the screen entry and exit zones as cooling water is provided to the zone to cool the polymer and prevent screen movement. Screen indexing can also be controlled by means of a time-based indexing cycle.

The belt filter can provide a relatively stable pressure during screen changes, but contamination levels must remain moderate to low. Seal adjustment is polymer-dependent, based on a given polymer's heating and cooling requirements, and heat/cool parameters must be adjusted to ensure the right amount of screen usage. Unlike manual and hydraulic screen changers, the screw cannot be pulled through the belt filter for removal.

A multi-layer film is described herein under an embodiment comprising an outer two layers of the multi-layer film comprising a linear low density polyethylene (LLDPE) butene resin, wherein the outer two layers comprise at least sixteen percent of the multi-layer film. A next two inwardly successive layers of the multi-layer film comprise a first linear low density polyethylene (LLDPE) hexene resin, wherein at least one of the next two inwardly successive layers comprises one or more recycled resin components, wherein at least one of the one or more recycled resin components are filtered using continuous filtration. A core layer of the multi-layer film comprises a second linear low density polyethylene (LLDPE) hexene resin. At least one edge of the multi-layer film comprises a folded edge.

The mLLDPE butene resin comprises a melt index of 2 g/10 min at 190 degrees, under an embodiment.

The LLDPE butene resin comprises a melt index from 1 to 3 g/10 min at 190 degrees, under an embodiment.

The multi-layer film of claim 1, wherein the LLDPE butene resin comprises a density of 0.919 g/cm³, under an embodiment.

The multi-layer film of claim 1, wherein the LLDPE butene resin comprises a density from 0.915 to 0.925 g/cm³, under an embodiment.

The first and the second LLDPE hexene resin comprises a melt index of 1 g/10 min at 190 degrees, under an embodiment.

The first and the second LLDPE hexene resin comprises a melt index from 1 to 5 g/10 min at 190 degrees, under an embodiment.

The first and the second LLDPE hexene resin comprises a density of 0.919 g/cm³, under an embodiment.

The first and the second LLDPE hexene resin comprises a density from 0.915 to 0.925 g/cm³, under an embodiment.

The one or more recycled resin components comprises a melt index of 2 g/10 min at 190 degrees, under an embodiment.

The one or more recycled resin components comprises a melt index from 0.1 to 5 g/10 min at 190 degrees, under an embodiment.

The one or more recycled resin components comprises a density of 0.919 g/cm³, under an embodiment.

The one or more recycled resin components comprises a density from 0.910 to 0.930 g/cm³, under an embodiment.

A method for producing a film is described herein under an embodiment, the method comprising providing a plurality of source materials for a coextrusion process, wherein the plurality of source materials comprises a linear low density polyethylene (LLDPE) butene resin, a linear low density polyethylene (LLDPE) hexene resin, and at least one recycled resin component, wherein the linear low density polyethylene (LLDPE) butene resin comprises at least sixteen percent of the film. The method includes filtering the at least one recycled resin component using continuous filtration. The method includes coextruding the plurality of materials into molten resins in producing the film. The method includes slitting the film into a plurality of sections. The method includes passing the plurality of sections across a first roller. The method includes moving the plurality of sections from the first roller to and through a folding mechanism, wherein the folding mechanism comprises one or more folding rods, wherein the movement through the folding mechanism comprises passing at least one edge of the plurality of sections along a corresponding folding rod of the one or more folding rods, wherein the corresponding folding rod of the one or more folding rods causes the at least one passing edge to fold upon itself and create an edge fold, wherein the edge fold comprises a first surface of the at least one passing edge clinging a second surface of the at least one passing edge.

An outer two layers of the multi-layer film comprises the linear low density polyethylene (LLDPE) butene resin, under an embodiment.

A next two inwardly successive layers of the multi-layer film comprises the linear low density polyethylene (LLDPE) hexene resin, under an embodiment.

A core layer of the multi-layer film comprises the linear low density polyethylene (LLDPE) hexene resin, under an embodiment.

At least one of the next two inwardly successive layers comprises one or more recycled resin components, under an embodiment.

The multi-layer film comprises eight microns or less, under an embodiment.

A method is described herein for producing a film under an embodiment, the method comprising providing a plurality of source materials for a coextrusion process, wherein the plurality of source materials comprises a linear low density polyethylene (LLDPE) butene resin, a linear low density polyethylene (LLDPE) hexene resin, and at least one recycled resin component, wherein the linear low density polyethylene (LLDPE) butene resin comprises at least sixteen percent of the film. The method includes filtering the at least one recycled resin component using continuous filtration. The method includes coextruding the plurality of materials into molten resins in producing the film. The method includes slitting the film into a plurality of sections. The method includes moving the plurality of sections through a folding mechanism, wherein the folding mechanism produces edge folds at edges of the plurality of sections. The method includes oscillating the folded plurality of sections. The method includes passing the folded plurality of section over a retractable roller that is parallel to a film roll and moves vertically away from the film roll at a separation rate that maintains a distance between the retractable roller and the film roll. The method includes winding the folded plurality of sections onto the film roll.

An outer two layers of the multi-layer film comprises a linear low density polyethylene (LLDPE) butene resin, under an embodiment.

A next two inwardly successive layers of the multi-layer film comprises a first linear low density polyethylene (LLDPE) hexene resin, under an embodiment.

At least one of the next two inwardly successive layers comprises one or more recycled resin components, under an embodiment.

A core layer of the multi-layer film comprises the linear low density polyethylene (LLDPE) hexene resin, under an embodiment.

The foregoing disclosure and is not intended to describe all possible aspects of the described embodiments. While embodiments set forth herein are described in detail, those of ordinary skill in the art will appreciate that minor changes to the description, and various other modifications, omissions and additions are also made without departing from the spirit or scope of the embodiments.

1. A multi-layer film comprising,
an outer two layers of the multi-layer film comprising a linear low density polyethylene (LLDPE) butene resin, wherein the outer two layers comprise at least sixteen percent of the multi-layer film;
a next two inwardly successive layers of the multi-layer film comprising a first linear low density polyethylene (LLDPE) hexene resin, wherein at least one of the next two inwardly successive layers comprises one or more recycled resin components, wherein at least one of the one or more recycled resin components are filtered using continuous filtration;
a core layer of the multi-layer film comprising a second linear low density polyethylene (LLDPE) hexene resin; and
at least one edge of the multi-layer film comprising a folded edge.

2. The multi-layer film of claim 1, wherein the mLLDPE butene resin comprises a melt index of 2 g/10 min at 190 degrees.

3. The multi-layer film of claim 1, wherein the LLDPE butene resin comprises a melt index from 1 to 3 g/10 min at 190 degrees.

4. The multi-layer film of claim 1, wherein the LLDPE butene resin comprises a density of 0.919 g/cm³.

5. The multi-layer film of claim 1, wherein the LLDPE butene resin comprises a density from 0.915 to 0.925 g/cm.

6. The multi-layer film of claim 1, wherein the first and the second LLDPE hexene resin comprises a melt index of 1 g/10 min at 190 degrees.

7. The multi-layer film of claim 1, wherein the first and the second LLDPE hexene resin comprises a melt index from 1 to 5 g/10 min at 190 degrees.

8. The multi-layer film of claim 1, wherein the first and the second LLDPE hexene resin comprises a density of 0.919 g/cm³.

9. The multi-layer film of claim 1, wherein the first and the second LLDPE hexene resin comprises a density from 0.915 to 0.925 g/cm³.

10. The multi-layer film of claim 1, wherein the one or more recycled resin components comprises a melt index of 2 g/10 min at 190 degrees.

11. The multi-layer film of claim 1, wherein the one or more recycled resin components comprises a melt index from 0.1 to 5 g/10 min at 190 degrees.

12. The multi-layer film of claim 1, wherein the one or more recycled resin components comprises a density of 0.919 g/cm³.

13. The multi-layer film of claim 1, wherein the one or more recycled resin components comprises a density from 0.910 to 0.930 g/cm³.

14. A method for producing a film, the method comprising,
providing a plurality of source materials for a coextrusion process, wherein the plurality of source materials comprises a linear low density polyethylene (LLDPE) butene resin, a linear low density polyethylene (LLDPE) hexene resin, and at least one recycled resin component, wherein the linear low density polyethylene (LLDPE) butene resin comprises at least sixteen percent of the film;
filtering the at least one recycled resin component using continuous filtration;
coextruding the plurality of materials into molten resins in producing the film;
slitting the film into a plurality of sections;
passing the plurality of sections across a first roller;
moving the plurality of sections from the first roller to and through a folding mechanism, wherein the folding mechanism comprises one or more folding rods, wherein the movement through the folding mechanism comprises passing at least one edge of the plurality of sections along a corresponding folding rod of the one or more folding rods, wherein the corresponding folding rod of the one or more folding rods causes the at least one passing edge to fold upon itself and create an edge fold, wherein the edge fold comprises a first surface of the at least one passing edge clinging a second surface of the at least one passing edge.

15. The method of claim 14, wherein an outer two layers of the multi-layer film comprises the linear low density polyethylene (LLDPE) butene resin.

16. The method of claim 14, wherein a next two inwardly successive layers of the multi-layer film comprises the linear low density polyethylene (LLDPE) hexene resin.

17. The method of claim 16, wherein a core layer of the multi-layer film comprises the linear low density polyethylene (LLDPE) hexene resin.

18. The method of claim 16, wherein at least one of the next two inwardly successive layers comprises one or more recycled resin components

19. The method of claim 14, wherein the multi-layer film comprises eight (8) microns or less.

20. A method for producing a film, the method comprising,
providing a plurality of source materials for a coextrusion process, wherein the plurality of source materials comprises a linear low density polyethylene (LLDPE) butene resin, a linear low density polyethylene (LLDPE) hexene resin, and at least one recycled resin component, wherein the linear low density polyethylene (LLDPE) butene resin comprises at least sixteen percent of the film;
filtering the at least one recycled resin component using continuous filtration;
coextruding the plurality of materials into molten resins in producing the film;
slitting the film into a plurality of sections;
moving the plurality of sections through a folding mechanism, wherein the folding mechanism produces edge folds at edges of the plurality of sections;
oscillating the folded plurality of sections;
passing the folded plurality of section over a retractable roller that is parallel to a film roll and moves vertically away from the film roll at a separation rate that maintains a distance between the retractable roller and the film roll;
winding the folded plurality of sections onto the film roll.

21. The method of claim 19, wherein an outer two layers of the multi-layer film comprises a linear low density polyethylene (LLDPE) butene resin.

22. The method of claim 19 wherein a next two inwardly successive layers of the multi-layer film comprises a first linear low density polyethylene (LLDPE) hexene resin.

23. The method of claim 22, wherein at least one of the next two inwardly successive layers comprises one or more recycled resin components.

24. The method of claim 20, wherein a core layer of the multi-layer film comprises the linear low density polyethylene (LLDPE) hexene resin.

25. The method of claim 20, wherein the multi-layer film comprises eight (8) microns or less.
